(19) United States
(12) Patent Application Publication
(10) Pub. No.: US 2007/0172741 A1
(43) Pub. Date: Jul. 26, 2007

(54) Non-aqueous electrolyte secondary cell and method for producing same

(75) Inventor: Taira Saito, Nishikamo-gun (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Moriguchi-shi (JP)

(21) Appl. No.: 11/657,731

(22) Filed: Jan. 25, 2007

(30) Foreign Application Priority Data
Jan. 26, 2006 (JP) 2006-017478

(51) Int. Cl. H01M 10/40; H01M 10/04

(52) U.S. Cl. 429/326; 29/623.1; 429/330

(57) ABSTRACT

An object of the present invention is to provide a non-aqueous electrolyte secondary cell that provides good wettability between the non-aqueous electrolyte and the separator and that is superior in cycle characteristics. This object is solved by a method for producing a non-aqueous electrolyte secondary cell, the cell having: an electrode assembly having a positive electrode, a negative electrode, and a separator located between the electrodes; and a non-aqueous electrolyte having an electrolytic salt and a non-aqueous solvent having a solvent with a dielectric constant of equal to or more than 30 at 25° C., the solvent being equal to or more than 50 volume %, the method having: adding in the non-aqueous electrolyte an isocyanate compound and a compound represented by R—(CH₂—CH₂—O—)ₙH where R is an alkyl derivative or a phenyl derivative, and n is an integer of equal to or more than 2; and allowing the two compounds to have an urethane bonding reaction therebetween.

### BACKGROUND OF THE INVENTION

1) Field of the Invention

The present invention relates to an improvement of a non-aqueous electrolyte secondary cell for the purpose of improving cycle characteristics and storage characteristics.

2) Description of the Related Art

In recent years, mobile information terminals such as mobile phones, notebook personal computers, and PDAs have been rapidly highly functionalized. As the driving power sources for the terminals, non-aqueous electrolyte secondary cells, which have a high capacity, are widely used.

In such non-aqueous electrolyte secondary cells, cyclic carbonate with high dielectric constant is usually used as a non-aqueous solvent for the non-aqueous electrolyte, and a polyolefin porous film is usually used as the separator. However, in this system, because there is poor wettability between the non-aqueous electrolyte and the separator, the charge/discharge reaction does not proceed smoothly, resulting in problems including deteriorated cycle characteristics.

Incidentally, in respect of a technique for improving wettability between the non-aqueous electrolyte and the separator, Patent Document 1 and Patent Document 2 disclose a technique comprising adding a surface active agent in the non-aqueous electrolyte.

Patent Document 1: Japanese Patent Application Publication No. 7-263027.

Patent Document 2: Japanese Patent Application Publication No. 10-12273.

### SUMMARY OF THE INVENTION

The present inventors conducted an extensive study on the technique described in the related-art documents. As a result, it has been found that although use of a surface active agent improves wettability between the non-aqueous electrolyte and the separator, cycle characteristics are not improved sufficiently. The present inventors further conducted a study on this finding and have found that the hydroxyl group contained in the surface active agent adversely affects the cycle characteristics, and that this problem is solved by employing means for eliminating the hydroxyl group contained in the surface active agent within the cell.

The present invention has been accomplished on the basis of the foregoing findings, and it is an object of the present invention to provide a non-aqueous electrolyte secondary cell that provides high wettability between the non-aqueous electrolyte and the separator, and that is superior in cycle characteristics and storage characteristics.

In order to accomplish the above and other objects, the present invention related to a method for producing a non-aqueous electrolyte secondary cell is configured as follows.

A method for producing a non-aqueous electrolyte secondary cell, the cell having: an electrode assembly having a positive electrode, a negative electrode, and a separator located between the electrodes; and a non-aqueous electrolyte having an electrolytic salt and a non-aqueous solvent having a solvent with a dielectric constant of equal to or more than 30 at 25° C., the solvent being equal to or more than 50 volume %, the method comprising:

adding in the non-aqueous electrolyte an isocyanate compound and a compound represented by
R—(CH₂—CH₂—O—)ₙH

where R is an alkyl derivative or a phenyl derivative, and n is an integer of equal to or more than 2; and

allowing the two compounds to have an urethane bonding reaction therebetween.

In this configuration, a compound represented by (R—(CH₂—CH₂—O—)ₙH), which has a hydrophilic ethylene oxide structure and a lipophilic alkyl derivative or phenyl derivative, is added in the non-aqueous electrolyte. Thereby wettability between the non-aqueous electrolyte and the separator and storage characteristics are exponentially improved.

Further, by adding in the non-aqueous electrolyte an isocyanate compound (R′—NCO where R′ is an alkyl derivative or a phenyl derivative), and allowing R—(CH₂—CH₂—O—)ₙH and the isocyanate compound to have an urethane bonding reaction therebetween, the hydroxyl group can be eliminated without generating toxic by-products (for example, water) by the reaction equation below. Thus, there is no adverse effects from the hydroxyl group, thereby significantly improving the storage characteristics and cycle characteristics.
R—(CH₂—CH₂—O—)ₙH+R′—N═C═O →R—(CH₂—CH₂—O—)ₙC(O)NHR′ Reaction equation

(where R is an alkyl derivative or a phenyl derivative, n is an integer of equal to or more than 2, R′ is an alkyl derivative or a phenyl derivative that is the same as or different from R, and the number of atoms of carbons in R′ is preferably equal to or less than 15, more preferably equal to or less than 10).

A non-aqueous solvent having a solvent with a dielectric constant of equal to or more than 30 at 25° C. has the effect of improving the stability of the non-aqueous electrolyte, especially stability in the case where excessive charging is carried out. In order to obtain this effect sufficiently, the solvent with a dielectric constant of equal to or more than 30 is preferably contained at equal to or more than 50 volume %

The alkyl derivative, as used herein, refers to a derivative that contains, to say nothing of an alkyl group, a functional group in which the hydrogen atom of the alkyl group is substituted by a phenyl group, a cycloalkyl group, a halogen, a sulfonyl group, and the like, or in which an ester group, a carbonate group, an ether group, and the like are introduced. The phenyl derivative, as used herein, refers to a derivative that contains, to say nothing of a phenyl group, a functional group in which the hydrogen atom of the alkyl group is substituted by an alkyl group, a cycloalkyl group, a halogen, a sulfonyl group, and the like, or in which an ester group, a carbonate group, an ether group, and the like are introduced. In particular, when a functional group with a high polarity such as a sulfonyl group, an ester group, and carbonate group is contained, the effect of improving compatibility between the non-aqueous electrolyte and the compound is obtained.

The number of n in the ethylene oxide is preferably equal to or more than 2 in order to obtain hydrophilicity. If the number of n is excessively large, the hydrophilicity becomes excessively strong, and the structure stability of the compound may be impaired. Thus, the number of n is preferably equal to or more than 2, more preferably equal to or more than 5 and equal to or less than 20.

The urethane bonding reaction proceeds if the cell is left at normal temperature (25° C.). Still, in order to promote the urethane bonding reaction, the cell may be heated at 40-60° C. for 30 minutes to 2 hours.

In this configuration, the content of the compound represented by R—(CH₂—CH₂—O—)ₙH is from 0.1 to 3.0 mass parts, and the content of the isocyanate compound is from 0.1 to 3.0 mass parts relative to 100 mass parts for addition of the non-aqueous solvent and the electrolytic salt.

If the content of the compound represented by R—(CH₂—CH₂—O—)ₙH is excessively small, a sufficient surface-active-agent effect cannot be obtained. If, on the other hand, the content of the compound represented by R—(CH₂—CH₂—O—)ₙH is excessively large, this compound itself lowers cell characteristics such as cycle characteristics. If the content of the isocyanate compound is excessively small, the hydroxyl group cannot be eliminated sufficiently, thus deteriorates cycle characteristics. If, on the other hand, the content of the isocyanate compound is excessively large, this compound itself lowers cell characteristics such as cycle characteristics. Thus, the above-specified ranges are preferred.

In this configuration, the isocyanate compound includes equal to or more than two isocyanate groups, and the method further comprises rendering the non-aqueous electrolyte a gel polymer using the isocyanate compound as a crosslinking agent.

If a compound including equal to or more than two isocyanate group is used as the isocyanate compound, and if the non-aqueous electrolyte is rendered a gel polymer using the isocyanate compound as a crosslinking agent, the advantageous effects of the present invention can be obtained sufficiently. In this case, it is preferably to add a monomer having two or more hydroxyl group. It is noted that a gel polymer preventive leak of non-aqueous electrolyte.

In order to accomplish the above and other objects, the present invention related to a non-aqueous electrolyte secondary cell is configured as follows.

A non-aqueous electrolyte secondary cell comprising:

an electrode assembly having a positive electrode, a negative electrode, and a separator located between the electrodes;

a non-aqueous electrolyte having an electrolytic salt and a non-aqueous solvent; and

an outer casing for housing the electrode assembly and the non-aqueous electrolyte, wherein:

the non-aqueous solvent has a solvent with a dielectric constant of equal to or more than 30 at 25° C.;

the solvent being equal to or more than 50 volume %; and

the non-aqueous electrolyte includes a compound containing an alkyl derivative structure or a phenyl derivative structure, an ethylene oxide structure, and an urethane structure, the compound being represented by
R—(CH₂—CH₂—O—)ₙC(O)NHR′

where R is an alkyl derivative or a phenyl derivative, n is an integer of equal to or more than 2, R′ is an alkyl derivative or a phenyl derivative that is the same as or different from R, and the number of atoms of carbons in R′ is preferably equal to or less than 15, more preferably equal to or less than 10.

In this configuration, the hydrophilic ethylene oxide structure and the lipophilic alkyl derivative structure provides a sufficient surface-active-agent effect (i.e., the effect of improving wettability against the separator), and the urethane structure eliminates the hydroxyl group contained in the ethylene oxide structure. Thus, a non-aqueous electrolyte secondary cell that provides high wettability between the non-aqueous electrolyte and the separator, and that is superior in cycle characteristics can be obtained.

In this configuration, the number of carbons contained in the alkyl derivative or the phenyl derivative is from 4 to 11.

If the number of carbons contained in the alkyl derivative or the phenyl derivative is excessively small, the lipophilicity becomes excessively weak, and thus a sufficient surface-active-agent effect cannot be obtained. If, on the other hand, the number of carbons is excessively large, the lipophilicity becomes excessively strong, and likewise, a sufficient surface-active-agent effect cannot be obtained. Thus, the above-specified ranges are preferred.

In this configuration, the outer casing is composed of a film having a metal layer and a resin layer stacked atop one another.

When a film having a metal layer and a resin layer stacked atop one another is used as the outer casing, the volume and mass of the cell can be decreased, making it possible to improve the volume energy and mass energy of the cell.

In this configuration, the non-aqueous electrolyte further includes vinylene carbonate.

Vinylene carbonate reacts with the negative electrode to form a stable covering film and thus acts to inhibit reaction between the negative electrode and the non-aqueous electrolyte. The content of the vinylene carbonate preferably from 0.1 to 5 mass %, more preferably from 1 to 3 mass %.

In this configuration, the non-aqueous electrolyte further includes vinyl ethylene carbonate.

Vinyl ethylene carbonate reacts with the negative electrode to form a stable covering film and thus acts to inhibit reaction between the negative electrode and the non-aqueous electrolyte. The content of the vinyl ethylene carbonate preferably from 0.1 to 5 mass %, more preferably from 1 to 3 mass %.

### DESCRIPTION OF THE PREFERRED EMBODIMENTS

Preferred embodiments of the present invention will be described in detail with reference to examples. It is noted that in the following description, the volume ratio of the non-aqueous solvent is adapted the conditions of 25° C. and 1 atm.

### EXAMPLE 1

<Preparation of the Positive Electrode>

A cobalt lithium compound oxide (LiCoO₂ as a positive electrode active material, and carbon black as a conducting agent, and polyvinylidene fluoride (PVDF) as a binding agent were mixed at a mass ratio of 90:5:5 and dispersed in an organic solvent made of N-Methyl-2-Pyrrolidone (NMP), thus preparing a positive electrode active material slurry.

Next, the positive electrode active material slurry was applied to both surfaces of a positive electrode core made of an aluminum foil of 15 μm thick so that the thickness would be uniform. Then, this electrode plate was passed through a drier to be dried, thereby removing the organic solvent (NMP) that was necessary during slurry preparation. After dried, the dried electrode plate was extended in a roll presser, and thus, a positive electrode plate of 125 μm thick was obtained.

<Preparation of the Negative Electrode>

Natural carbon with a particle diameter of 15-30 μm as a negative electrode active material and polyvinylidene fluoride (PVDF) as a binding agent were mixed at a mass ratio of 90:10 and dispersed in an organic solvent made of N-Methyl-2-Pyrrolidone (NMP), thus preparing a negative electrode active material slurry.

Next, the negative electrode active material slurry was applied to both surfaces of a negative electrode core made of a copper foil of 10 μm thick so that the thickness would be uniform. Then, this electrode plate was passed through a drier to remove the organic solvent (NMP). After dried, the dried electrode plate was extended in a roll presser, and thus, a negative electrode plate of 120 μm thick was obtained.

<Preparation of the Electrode Assembly>

The positive electrode plate, the negative electrode plate, and a separator made of a polyethylene porous film were wound using a winder, taped with an insulating tape, and then pressed, thus completing a flat electrode assembly.

<Preparation of the Non-Aqueous Electrolyte> (Adding Step)

In a non-aqueous having mixed therein ethylene carbonate (EC; dielectric constant: 90) and polypropylene carbonate (PC; dielectric constant: 65) at a volume ratio of 50:50, LiPF₆ as the electrolytic salt was dissolved at a rate of 1.0 (mol/liter), thus obtaining an electrolytic solution. To 10 mass parts of this electrolytic solution, 1 mass part of vinylene carbonate (VC), 1 mass part of vinyl ethylene carbonate (VEC), 0.5 mass part of polyethylene glycol octyl ether (PEGOE: ethylene oxide compound), and 0.5 mass part of phenyl isocyanate were added, thus obtaining a non-aqueous electrolyte.

<Preparation of the Cell> (Reaction Step)

After preparing a sheet laminate material of five layer structure with resin layer (polypropylene)/adhesive layer/aluminum alloy layer/adhesive layer/resin layer (polypropylene), this aluminum laminate material was folded to form a bottom portion, and the flat electrode assembly and the non-aqueous electrolyte were inserted into the storage space of an aluminum laminate outer casing of three-side sealed structure in which three sides of the resulting flat shape were sealed (the bottom portion excluded). Then, the inside of the outer casing was depressurized to fill the inside of the separator with the non-aqueous electrolyte, after which the opening portion of the outer casing was sealed. Then the resulting product was left at 50° C. for one hour to allow the polyethylene glycol octyl ether and phenyl isocyanate to react with each other, thus obtaining a non-aqueous electrolyte secondary cell according to example 1.

After preparing this cell, the cell was disassembled to measure the infrared absorption spectrum of the non-aqueous electrolyte, and it has been confirmed that the absorption was in the vicinity of 3460-3440 cm⁻¹ and 3320-3270 cm⁻¹. This is a result of an urethane structure generated by an urethane bonding between the hydroxyl group of the polyethylene glycol octyl ether and the isocyanate group of the phenyl isocyanate.

### EXAMPLE 2

A non-aqueous electrolyte secondary cell according to example 2 was prepared in the same manner as in example 1 except that instead of the polyethylene glycol octyl ether, polyethylene glycol perfluoro octyl ether (PEGPFOE) was used as the ethylene oxide compound.

### EXAMPLE 3

A non-aqueous electrolyte secondary cell according to example 3 was prepared in the same manner as in example 1 except that instead of the polyethylene glycol octyl ether, polyethylene glycol butyl phenyl ether (PEGBPE) was used as the ethylene oxide compound.

### EXAMPLE 4

A non-aqueous electrolyte secondary cell according to example 4 was prepared in the same manner as in example 1 except that instead of the polyethylene glycol octyl ether, polyethylene glycol monolaurate (PEGML) was used as the ethylene oxide compound.

### EXAMPLE 5

A non-aqueous electrolyte secondary cell according to example 5 was prepared in the same manner as in example 1 except that instead of the polyethylene glycol octyl ether, polyethylene glycol propyl ether (PEGPE) was used as the ethylene oxide compound.

### EXAMPLE 6

A non-aqueous electrolyte secondary cell according to example 6 was prepared in the same manner as in example 1 except that instead of the polyethylene glycol octyl ether, polyethylene glycol butyl ether (PEGBE) was used as the ethylene oxide compound.

### EXAMPLE 7

A non-aqueous electrolyte secondary cell according to example 7 was prepared in the same manner as in example 1 except that instead of the polyethylene glycol octyl ether, polyethylene glycol undecyl ether (PEGUE) was used as the ethylene oxide compound.

### EXAMPLE 8

A non-aqueous electrolyte secondary cell according to example 8 was prepared in the same manner as in example 1 except that instead of the polyethylene glycol octyl ether, polyethylene glycol tridecyl ether (PEGUE) was used as the ethylene oxide compound.

### EXAMPLE 9

A non-aqueous electrolyte secondary cell according to example 9 was prepared in the same manner as in example 1 except that ethyl isocyanate was used instead of the phenyl isocyanate.

### COMPARATIVE EXAMPLE 1

A non-aqueous electrolyte secondary cell according to comparative example 1 was prepared in the same manner as in example 1 except that the phenyl isocyanate was not added.

### COMPARATIVE EXAMPLE 2

A non-aqueous electrolyte secondary cell according to comparative example 2 was prepared in the same manner as in example 1 except that the polyethylene glycol octyl ether was not added.

### COMPARATIVE EXAMPLE 3

A non-aqueous electrolyte secondary cell according to comparative example 2 was prepared in the same manner as in example 1 except that the polyethylene glycol octyl ether and phenyl isocyanate were not added.

[Wettability Test Against the Separator]

The assembled cell was disassembled to visually inspect the wettability of the separator. The case where the separator was entirely wet was evaluated as ∘, the case where the separator was wet to some degree was evaluated as Δ, and the case where the separator was not substantially wet was evaluated as x. The results are shown in Table 1.

[Storage Characteristics Test]

Each cell was charged at a constant current of 1 It (600 mA) until voltage became 4.2 V, and then charged at a constant voltage of 4.2 V until current became 30 mA. The charged cell was left in an environment of 80° C. to measure the cell thickness before and after storage. The amount of increase in the cell thickness after storage is shown in Table 1.

[Cycle Characteristics Test]

Charge/discharge cycles were carried out under the following conditions, and a value obtained by (500th cycle discharge capacity/1st cycle discharge capacity×100) was assume cycle characteristics. This value is shown in Table 1.

<Cycle Conditions>

(1) Each cell was charged at a constant current of 1 It (600 mA) until voltage became 4.2 V, and then charged at a constant voltage of 4.2 V until current became 30 mA.

(2) 10-minute pause.

(3) Each cell was charged at a constant current of 1 It (600 mA) until voltage became 2.75 V.

(4) 10-minute pause.

TABLE 1

| | | | | Increased | |
|---|---|---|---|---|---|
| | | | | thickness | |
| | | | | amount | Cycle |
| | Ethylene | Isocyanate | | after | charac- |
| | oxide | compound | Wetta- | storage | teristics |
| | species | species | bility | (mm) | (%) |
| Ex. 1 | PEGOE | phenyl | ∘ | 0.2 | 84 |
| | | isocyanate | | | |
| Ex. 2 | PEGPFOE | phenyl | ∘ | 0.2 | 87 |
| | | isocyanate | | | |
| Ex. 3 | PEGBPE | phenyl | ∘ | 0.2 | 85 |
| | | isocyanate | | | |
| Ex. 4 | PEGML | phenyl | ∘ | 0.2 | 85 |
| | | isocyanate | | | |
| Ex. 5 | PEGPE | phenyl | Δ | 0.4 | 72 |
| | | isocyanate | | | |
| Ex. 6 | PEGBE | phenyl | ∘ | 0.2 | 84 |
| | | isocyanate | | | |
| Ex. 7 | PEGUE | phenyl | ∘ | 0.2 | 82 |
| | | isocyanate | | | |
| Ex. 8 | PEGTE | phenyl | ∘ | 0.5 | 60 |
| | | isocyanate | | | |
| Ex. 9 | PEGOE | ethyl | ∘ | 0.2 | 84 |
| | | isocyanate | | | |
| Com. | PEGOE | — | ∘ | 0.8 | 52 |
| Ex. 1 | | | | | |
| Com. | — | phenyl | x | — | — |
| Ex2 | | isocyanate | | | |
| Com. | — | — | x | — | — |
| Ex3 | | | | | |

In Table 1, the cells evaluated as × for wettability between the separator and the non-aqueous electrolyte could not be charged and discharged, and therefore were not subjected to the storage characteristics test and the cycle characteristics test.

It can be seen from Table 1 that examples 1 to 9 and comparative example 1, in which an ethylene oxide compound was added, were evaluated as Δ or ∘ for wettability between the separator and the non-aqueous electrolyte and thus are superior to comparative examples 2 and 3, in which no ethylene oxide compound was added and which were evaluated as × for wettability. It is believed that the ethylene oxide compound acted to improve wettability between the separator and the non-aqueous electrolyte.

It can be seen from Table 1 that comparative example 1, in which an ethylene oxide compound was added and no isocyanate compound was added, had a cell thickness of 0.8 mm after storage, which is a great expansion compared with 0.2 to 0.5 mm for examples 1 to 9, in which both ethylene oxide compound and isocyanate compound were added.

It is believed that the hydroxyl group contained in the ethylene oxide compound promoted the decomposition reaction of the electrolytic solution, and thus gas was generated within the cell. Contrarily, in examples 1 to 9, the hydroxyl group contained in the ethylene oxide compound had an urethane bonding reaction with the isocyanate compound and thus was eliminated. Thus, the above problem did not occur.

It can be seen from Table 1 that example 5, which used polyethylene glycol propyl ether (the number of carbon atoms in the carbon chain was 3) as the ethylene oxide compound, was evaluated as Δ for wettability between the separator and the non-aqueous electrolyte, that is, had poorer wettability than that of examples 1, 6-8, in which the number of carbon atoms in the carbon chain was equal to or more than 4. It is believed that because the number of carbon atoms in the carbon chain was excessively small, the lipophilicity of the ethylene oxide compound became low, making it impossible to sufficiently improve the wettability.

It can be seen from Table 1 that in example 8, polyethylene glycol tridecyl ether (the number of carbon atoms in the carbon chain was 13) as the ethylene oxide compound, had an increased thickness of 0.5 mm after storage and cycle characteristics of 60%, which were inferior to 0.2 mm and 82 to 84%, respectively, for examples 1, 6, and 7, in which the number of carbon atoms in the carbon chain was 4 to 11.

It is believed that because the number of carbon atoms in the carbon chain was excessively large, the lipophilicity of the ethylene oxide compound became excessively high, and thus a smooth charge/discharge reaction was interfered, though the wettability was improved.

Thus, it can be seen that the number of carbon atoms in the carbon chain of the ethylene oxide compound is 4 to 11.

### EXAMPLE 10

A non-aqueous electrolyte secondary cell according to example 10 was prepared in the same manner as in example 1 except for using, as the non-aqueous solvent, a mixture of 40 volume parts of ethylene carbonate (EC), 40 volume parts of propylene carbonate (PC), and 20 volume parts of diethyl carbonate (DEC; dielectric constant: 2.8).

### EXAMPLE 11

A non-aqueous electrolyte secondary cell according to example 11 was prepared in the same manner as in example 1 except for using, as the non-aqueous solvent, a mixture of 30 volume parts of ethylene carbonate (EC), 20 volume parts of propylene carbonate (PC), and 50 volume parts of diethyl carbonate (DEC).

### COMPARATIVE EXAMPLE 4

A non-aqueous electrolyte secondary cell according to comparative example 4 was prepared in the same manner as in example 1 except for using, as the non-aqueous solvent, a mixture of 30 volume parts of ethylene carbonate (EC) and 70 volume parts of diethyl carbonate (DEC).

### COMPARATIVE EXAMPLE 5

A non-aqueous electrolyte secondary cell according to comparative example 5 was prepared in the same manner as in example 10 except that the polyethylene glycol octyl ether and phenyl isocyanate were not added.

### COMPARATIVE EXAMPLE 6

A non-aqueous electrolyte secondary cell according to comparative example 6 was prepared in the same manner as in example 11 except that the polyethylene glycol octyl ether and phenyl isocyanate were not added.

### COMPARATIVE EXAMPLE 7

A non-aqueous electrolyte secondary cell according to comparative example 7 was prepared in the same manner as in comparative example 4 except that the polyethylene glycol octyl ether was not added.

### COMPARATIVE EXAMPLE 8

A non-aqueous electrolyte secondary cell according to comparative example 8 was prepared in the same manner as in example 4 except that the polyethylene glycol octyl ether and phenyl isocyanate were not added.

The cells of examples 1, 10, 11, and comparative examples 3 to 8 were subjected to the wettability test, storage characteristics test, and cycle characteristics test. The results are shown in Table 2.

Also, an overcharge test was carried out under the following conditions, and the case where the cell temperature was lower than 140° C. was evaluated as good (∘), and the case where the cell temperature was equal to or higher than 140° C. was evaluated as not good (×). The results are shown in Table 2.

TABLE 2

| | | | | | Increased | | | | |
|---|---|---|---|---|---|---|---|---|---|
| | | | | | thickness | | | | |
| | | | phenyl | | amount after | Cycle | Overcharge test | | |
| | EC:PC:DEC | PEGOE | isocyanate | Wettability | storage (m) | Characteristics | 0.6It | 1.2It | 2.0It |
| Ex. 1 | 50:50:0 | ∘ | ∘ | ∘ | 0.2 | 84 | ∘ | ∘ | ∘ |
| Ex. 10 | 40:40:20 | ∘ | ∘ | ∘ | 0.2 | 84 | ∘ | ∘ | ∘ |
| Ex. 11 | 30:20:50 | ∘ | ∘ | ∘ | 0.2 | 84 | ∘ | ∘ | x |
| Com. | 30:0:70 | ∘ | ∘ | ∘ | 0.2 | 85 | ∘ | x | x |
| Ex. 4 | | | | | | | | | |
| Com. | 50:50:0 | — | — | x | — | — | — | — | — |
| Ex. 3 | | | | | | | | | |
| Com. | 40:40:20 | — | — | Δ | 0.6 | 71 | ∘ | ∘ | ∘ |
| Ex. 5 | | | | | | | | | |
| Com. | 30:20:50 | — | — | Δ | 0.5 | 75 | ∘ | ∘ | x |
| Ex. 6 | | | | | | | | | |
| Com. | 30:0:70 | ◯ | — | ∘ | 0.7 | 55 | ∘ | x | x |
| Ex. 7 | | | | | | | | | |
| Com. | 30:0:70 | — | — | ∘ | 0.3 | 82 | ∘ | x | x |
| Ex. 8 | | | | | | | | | |

In Table 2, the cells evaluated as × for wettability between the separator and the non-aqueous electrolyte could not be charged and discharged, and therefore were not subjected to the storage characteristics test, cycle characteristics test and overcharge test.

It can be seen from Table 2 that as the content of the diethyl carbonate (DEC), which had a low dielectric constant, increased, the wettability improved even if the polyethylene glycol octyl ether (PEGOE) was not added (see comparative examples 3, 5, 6, 8). Also, it can be seen that in the case where the content of the diethyl carbonate (DEC), which had a low dielectric constant, became 70 volume %, there was no difference in the wettability between the case where the polyethylene glycol octyl ether was added and the case where the polyethylene glycol octyl ether was not added (see comparative examples 7, 8).

It is believed that because the diethyl carbonate, which has a low dielectric constant, has a carbonate group, which has a high polarity, and an ethyl group, which has a low polarity, this compound itself acts to improve the wettability against the separator.

It can be seen from Table 2 that as the content of the diethyl carbonate (DEC), which had a low dielectric constant, increased, the overcharge security tended to decrease (see examples 1, 10, 11, comparative examples 4).

This is considered as follows. Since the diethyl carbonate has a low dielectric constant, as the content thereof increases, the stability of the non-aqueous electrolyte is deteriorated. Thus, if overcharge is carried out at a high rate of equal to or more than 1.2 It, the cell temperature abnormally increases, thus impairing the security of the cell. Thus, the content of a high-dielectric-constant solvent with a dielectric constant of equal to or more than 30 is preferably equal to or more than 50 volume %.

It can be seen from Table 2 that in comparative examples 5 and 6, in which the content of the low-dielectric-constant diethyl carbonate (DEC) was respectively 20 volume % and 50 volume % and no ethylene oxide compound was added, the increased amount of cell thickness was 0.5-0.6 mm, which is a great expansion.

It is believed that since in comparative examples 5 and 6, in which the content of the low-dielectric-constant diethyl carbonate (DEC) was respectively 20 volume % and 50 volume % and no ethylene oxide compound was added, wettability between the separator and the non-aqueous electrolyte was not sufficient (evaluated as Δ), a smooth charge/discharge reaction was prevented, and thus the electrolytic solution was dissolved.

### EXAMPLE 12

A non-aqueous electrolyte secondary cell according to example 12 was prepared in the same manner as in example 1 except that the content of the polyethylene glycol octyl ether (PEGOE) was 0.01 mass %.

### EXAMPLE 13

A non-aqueous electrolyte secondary cell according to example 13 was prepared in the same manner as in example 1 except that the content of the polyethylene glycol octyl ether (PEGOE) was 0.1 mass %.

### EXAMPLE 14

A non-aqueous electrolyte secondary cell according to example 14 was prepared in the same manner as in example 1 except that the content of the polyethylene glycol octyl ether (PEGOE) was 1 mass %.

### EXAMPLE 15

A non-aqueous electrolyte secondary cell according to example 15 was prepared in the same manner as in example 1 except that the content of the polyethylene glycol octyl ether (PEGOE) was 3 mass %.

### EXAMPLE 16

A non-aqueous electrolyte secondary cell according to example 16 was prepared in the same manner as in example 1 except that the content of the polyethylene glycol octyl ether (PEGOE) was 5 mass %.

The cells of examples 1, 12 to 16, and comparative example 2 were subjected to the wettability test, storage characteristics test, and cycle characteristics test. The results are shown in Table 3.

TABLE 3

| | | | Increased | |
|---|---|---|---|---|
| | | | thickness | |
| | | | amount | |
| | PEGOE | | after | Cycle |
| | content | | storage | characteristics |
| | (mass %) | Wettability | (mm) | (%) |
| Com. Ex. 2 | 0 | x | — | — |
| Ex. 12 | 0.01 | Δ | 0.5 | 70 |
| Ex. 13 | 0.1 | ∘ | 0.2 | 85 |
| Ex. 1 | 0.5 | ∘ | 0.2 | 84 |
| Ex. 14 | 1.0 | ∘ | 0.2 | 84 |
| Ex. 15 | 3.0 | ∘ | 0.3 | 80 |
| Ex. 16 | 5.0 | ∘ | 0.5 | 65 |

In Table 3, the cells evaluated as × for wettability between the separator and the non-aqueous electrolyte could not be charged and discharged, and therefore were not subjected to the storage characteristics test and the cycle characteristics test.

It can be seen from Table 3 that in comparative example 2 and example 12, in which the content of the polyethylene glycol octyl ether (PEGOE) was lower than 0.01 mass %, the wettability could not be sufficiently improved, accordingly deteriorating the cycle characteristics.

It is believed that if the content of the polyethylene glycol octyl ether (PEGOE) is excessively small, wettability between the separator and the non-aqueous electrolyte cannot be improved, thus deteriorating the cycle characteristics.

It can be seen from Table 3 that example 16, in which the content of the polyethylene glycol octyl ether (PEGOE) was 5.0 mass %, had cycle characteristics of 65%, which was lower than 80-85% for examples 1 and 13 to 15, in which the content of PEGOE was 0.1 to 3.0 mass %, although example 16 had sufficient wettability.

It is believed that if the content of the polyethylene glycol octyl ether (PEGOE) is excessively large, this compound itself acts to interfere charge and discharge, thereby lowering the cycle characteristics.

### EXAMPLE 17

A non-aqueous electrolyte secondary cell according to example 17 was prepared in the same manner as in example 1 except that the content of the phenyl isocyanate was 0.01 mass %.

### EXAMPLE 18

A non-aqueous electrolyte secondary cell according to example 18 was prepared in the same manner as in example 1 except that the content of the phenyl isocyanate was 0.1 mass %.

### EXAMPLE 19

A non-aqueous electrolyte secondary cell according to example 19 was prepared in the same manner as in example 1 except that the content of the phenyl isocyanate was 1 mass %.

### EXAMPLE 20

A non-aqueous electrolyte secondary cell according to example 20 was prepared in the same manner as in example 1 except that the content of the phenyl isocyanate was 3 mass %.

### EXAMPLE 21

A non-aqueous electrolyte secondary cell according to example 21 was prepared in the same manner as in example 1 except that the content of the phenyl isocyanate was 5 mass %.

The cells of examples 1, 17 to 21, and comparative example 1 were subjected to the wettability test, storage characteristics test, and cycle characteristics test. The results are shown in Table 4.

TABLE 4

| | | | Increased | |
|---|---|---|---|---|
| | | | thickness | |
| | Phenyl | | amount | |
| | isocyanate | | after | Cycle |
| | content | | storage | characteristics |
| | (mass %) | Wettability | (mm) | (%) |
| Com. Ex. 1 | 0 | ∘ | 0.8 | 52 |
| Ex. 17 | 0.01 | ∘ | 0.5 | 62 |
| Ex. 18 | 0.1 | ∘ | 0.2 | 84 |
| Ex. 1 | 0.5 | ∘ | 0.2 | 84 |
| Ex. 19 | 1.0 | ∘ | 0.2 | 83 |
| Ex. 20 | 3.0 | ∘ | 0.3 | 80 |
| Ex. 21 | 5.0 | ∘ | 0.5 | 60 |

It can be seen from Table 4 that in comparative example 1 and example 17, in which the content of the phenyl isocyanate was lower than 0.01 mass %, had cycle characteristics 52% and 62%, respectively, which were lower than 80-84% for examples 1, 18 to 20, in which the content of the phenyl isocyanate was 0.1 to 3.0 mass %.

It is believed that if the content of the phenyl isocyanate is excessively small, the hydroxyl group contained in the ethylene oxide compound cannot be sufficiently eliminated, and thus the remaining hydroxyl group lowers the cycle characteristics.

It can be seen from Table 4 that example 21, in which the content of the phenyl isocyanate was 5.0 mass %, had cycle characteristics of 60%, which was lower than 80-84% for examples 1, 18 to 20, in which the content of the phenyl isocyanate was 0.1 to 3.0 mass %, although example 21 had sufficient wettability.

It is believed that if the content of the phenyl isocyanate excessively large, this compound itself acts to interfere charge and discharge, thereby lowering the cycle characteristics.

### EXAMPLE 22

A non-aqueous electrolyte secondary cell according to example 22 was prepared in the same manner as in example 1 except that 5 mass parts of polyethylene glycol diacrylate and 0.5 mass part of t-hexyl peroxypivalate as a polymerization initiator were further added in the non-aqueous electrolyte to obtain a prepolymer non-aqueous electrolyte, and the prepolymer non-aqueous electrolyte was injected into the outer casing, and after depressurization and sealing, a polymerization reaction was carried out at 60° C. for 5 hours.

### EXAMPLE 23

A non-aqueous electrolyte secondary cell according to example 23 was prepared in the same manner as in example 22 except that hexamethylenediisocyanate was added instead of the phenyl isocyanate, polyvinyl formal resin was added instead of the polyethylene glycol diacrylate, and no polymerization initiator was added. Although no polymerization initiator was added, the hexamethylenediisocyanate (a diisocyanate compound) contributes to polymer formation as a crosslinking agent.

### EXAMPLE 24

A non-aqueous electrolyte secondary cell according to example 24 was prepared in the same manner as in example 23 except that norbornenediisocyanate was added instead of the hexamethylenediisocyanate.

### EXAMPLE 25

A non-aqueous electrolyte secondary cell according to example 25 was prepared in the same manner as in example 23 except that polyethylene glycol perfluoro octyl ether was added instead of the polyethylene glycol octyl ether.

### COMPARATIVE EXAMPLE 9

A non-aqueous electrolyte secondary cell according to comparative example 9 was prepared in the same manner as in example 22 except that no phenyl isocyanate was added.

### COMPARATIVE EXAMPLE 10

A non-aqueous electrolyte secondary cell according to comparative example 10 was prepared in the same manner as in example 22 except that both phenyl isocyanate and polyethylene glycol octyl ether were not added.

### COMPARATIVE EXAMPLE 11

A non-aqueous electrolyte secondary cell according to comparative example 11 was prepared in the same manner as in example 23 except that no polyethylene glycol octyl ether was added.

When the cells of examples 22 to 25 and comparative example 9 to 11 were disassembled, it was confirmed that the non-aqueous electrolytes were gelated.

The cells of examples 22 to 25 and comparative examples 9 to 11 were subjected to the wettability test, storage characteristics test, and cycle characteristics test. The results are shown in Table 5. It is noted that the wettability test was carried out before the polymerization reaction.

TABLE 5

| | | Increased | |
|---|---|---|---|
| | | thickness | |
| | | amount | |
| | | after | Cycle |
| | | storage | characteristics |
| | Wettability | (mm) | (%) |
| Ex. 22 | ∘ | 0.3 | 80 |
| Ex. 23 | ∘ | 0.2 | 82 |
| Ex. 24 | ∘ | 0.2 | 81 |
| Ex. 25 | ∘ | 0.2 | 85 |
| Com. Ex. 9 | ∘ | 0.8 | 49 |
| Com. Ex. 10 | x | — | — |
| Com. Ex. 11 | x | — | — |

In Table 5, the cells evaluated as × for wettability between the separator and the non-aqueous electrolyte could not be charged and discharged, and therefore were not subjected to the storage characteristics test and cycle characteristics test.

It can be seen from Table 5 that also in the case where the present invention is applied to cells using gel polymer non-aqueous electrolyte, advantageous effects similar to the case of a liquid non-aqueous electrolyte are obtained.

(Supplementary Remarks)

As the positive electrode active material used for the non-aqueous electrolyte secondary cell according to the present invention, in place of the above-described cobalt acid lithium, a lithium-containing transition metal complex oxide can be used such as a nickel lithium complex oxide (LiNiO₂), a spinel manganese lithium complex oxide (LiMn₂O₄), a layered manganese lithium complex oxide (LiMnO₂), iron lithium complex oxide (LiFeO₂), and an oxide in which a part of the transition metal contained in any of the foregoing oxides is substituted by another element. These oxides can be used alone or in combination of two or more of the foregoing.

As the negative electrode material, natural graphite, artificial graphite, carbon black, corks, glass carbon, carbon fiber, or a carbonaceous matter such as a burned substance of the foregoing, or a mixture of the carbonaceous matter and one selected from the group consisting of lithium, a lithium alloy, and a metal oxide capable of intercalating and disintercalating lithium can be used.

The non-aqueous solvent is not limited to the combinations specified in the above examples: for example, a high-dielectric-constant solvent with a dielectric constant of equal to or more than 50 can be used such as butylene carbonate and γ-butyrolactone. In addition to a high-dielectric-constant solvent, a low viscous solvent can be mixed such as diethyl carbonate, dimethyl carbonate, ethyl methyl carbonate, 1,2-dimethoxyethane, tetrahydrofuran, anisole, 1,4-dioxane, 4-methyl-2-pentanone, cyclohexanone, acetonitrile, propionitrile, dimethylformamide, sulfolan, methyl formate, ethyl formate, methyl acetate, ethyl acetate, propyl acetate, and ethyl propionate. The content of the high-dielectric-constant solvent is preferably equal to or more than 50 mass % of the entire non-aqueous solvent. It is also possible to use a mixture solvent of two or more high-dielectric-constant solvents and two or more low viscous solvents. As the electrolytic salt, instead of LiPF₆, for example, LiN(C₂F₅SO₂)₂, LiN(CF₃SO₂)₂, LiClO₄, or LiBF₄ can be used alone or in combination of equal to or more than two of the foregoing.

Although the vinylene carbonate and vinyl ethylene carbonate are not essential constituent of the present invention, addition of the carbonates forms a covering film of good quality on the surface of the electrodes and thus provides the effect of inhibiting the decomposition of the non-aqueous electrolyte. It is also possible to use, instead of the vinylene carbonate and vinyl ethylene carbonate, a substance in which the hydrogen atom contained in any of the foregoing carbonates is substituted by an alkyl group with equal to or less than 6 carbon atoms.

As described hereinbefore, according to the present invention, a non-aqueous electrolyte secondary cell that provides good wettability between the non-aqueous electrolyte and the separator and that is superior in cycle characteristics is provided. Therefore, industrial applicability is considerable.

What is claimed is:

1. A method for producing a non-aqueous electrolyte secondary cell, the cell having: an electrode assembly having a positive electrode, a negative electrode, and a separator located between the electrodes; and a non-aqueous electrolyte having an electrolytic salt and a non-aqueous solvent having a solvent with a dielectric constant of equal to or more than 30 at 25° C., the solvent being equal to or more than 50 volume %, the method comprising:
adding in the non-aqueous electrolyte an isocyanate compound and a compound represented by
R—(CH₂—CH₂—O—)ₙH
where R is an alkyl derivative or a phenyl derivative, and n is an integer of equal to or more than 2; and
allowing the two compounds to have an urethane bonding reaction therebetween.

2. The method according to claim 1, wherein the content of the compound represented by R—(CH₂—CH₂—O—)ₙH is from 0.1 to 3.0 mass parts, and the content of the isocyanate compound is from 0.1 to 3.0 mass parts relative to 100 mass parts for addition of the non-aqueous solvent and the electrolytic salt.

3. The method according to claim 1, wherein:
the isocyanate compound includes equal to or more than two isocyanate groups; and
the method further comprises rendering the non-aqueous electrolyte a gel polymer using the isocyanate compound as a crosslinking agent.

4. The method according to claim 2, wherein:
the isocyanate compound includes equal to or more than two isocyanate groups; and
the method further comprises rendering the non-aqueous electrolyte a gel polymer using the isocyanate compound as a crosslinking agent.

5. The method according to claim 1, wherein the reaction step comprises heating the cell at 40° C. to 60° C. for 30 minutes to 2 hours.

6. A non-aqueous electrolyte secondary cell comprising:
an electrode assembly having a positive electrode, a negative electrode, and a separator located between the electrodes;
a non-aqueous electrolyte having an electrolytic salt and a non-aqueous solvent; and
an outer casing for housing the electrode assembly and the non-aqueous electrolyte, wherein:
the non-aqueous solvent has a solvent with a dielectric constant of equal to or more than 30 at 25° C.;
the solvent being equal to or more than 50 volume %; and
the non-aqueous electrolyte includes a compound containing an alkyl derivative structure or a phenyl derivative structure, an ethylene oxide structure, and an urethane structure, the compound being represented by
R—(CH₂—CH₂—O—)ₙC(O)NHR′
where R is an alkyl derivative or a phenyl derivative, n is an integer of equal to or more than 2, R′ is an alkyl derivative or a phenyl derivative that is the same as or different from R, and the number of atoms of carbons in R′ is preferably equal to or less than 15, more preferably equal to or less than 10.

7. The non-aqueous electrolyte secondary cell according to claim 6, wherein the number of carbons contained in the alkyl derivative or the phenyl derivative is from 4 to 11.

8. The non-aqueous electrolyte secondary cell according to claim 6, wherein the outer casing is composed of a film having a metal layer and a resin layer stacked atop one another.

9. The non-aqueous electrolyte secondary cell according to claim 7, wherein the outer casing is composed of a film having a metal layer and a resin layer stacked atop one another.

10. The non-aqueous electrolyte secondary cell according to claim 6, wherein the non-aqueous electrolyte further includes vinylene carbonate.

11. The non-aqueous electrolyte secondary cell according to claim 6, wherein the non-aqueous electrolyte further includes vinyl ethylene carbonate.
